(19) United States
(12) Patent Application Publication
(10) Pub. No.: US 2024/0227257 A9
(43) Pub. Date: Jul. 11, 2024

(54) METHOD FOR APPLYING A SEAL TO A PLATE

(71) Applicant: SPLIFAR S.A., Fleurus (BE)

(72) Inventors: Olivier JENNES, Fleurus (BE); Candido MURILLO, Fleurus (BE); Giovanni SCAGLIOLA, Fleurus (BE)

(73) Assignee: SPLIFAR S.A., Fleurus (BE)

(21) Appl. No.: 18/546,304

(22) PCT Filed: Feb. 14, 2022
(86) PCT No.: PCT/EP2022/053527

§ 371 Date: Aug. 14, 2023

(30) Foreign Application Priority Data
Feb. 15, 2021 (EP) 21157131.0

(51) Int. Cl. B29C 45/14

(52) U.S. Cl. CPC B29C 45/14065; B29C 45/14434; B29C 45/14836; B29K 2075/00

(57) ABSTRACT

A method for applying a seal onto a plate, including, providing a tool containing at least one support element made of solid material including a recess, a support element made of flexible material including a first part and a second part where said support element made of flexible material is arranged at least partially in said recess, and a means for exerting a pressure in a compensation chamber of said recess, where said compensation chamber is delimited at least partially by said second part of said support element made of flexible material.

### FIELD OF INVENTION

The present invention relates to a method for applying a seal onto the edge of interest of a plate. More particularly, the present invention concerns a method for applying a seal onto the edge of interest of a glass plate and more particularly a large glass plate.

### BACKGROUND OF THE INVENTION

Methods are known to provide a seal along the periphery of the plate or more particularly along the periphery of glass plate. Such a method is for example known from document EP 0 409 091. The plate is usually formed by a glass panel arranged to be mounted in a body of a vehicle. To mount the glass panel in a body, a seal extending along at least a portion of the edge of the panel is used.

A plurality of methods are currently used to apply a seal onto a plate.

An already-preformed seal can be glued or fitted onto the plate. European patent EP 1 361098 describes a method for gluing a preformed seal onto a plate using an adhesive strip. The seal is pressed between the various portions of a flange and the plate is then pushed onto the seal.

Alternatively, the seal is produced directly on the plate either by the extrusion method or by an injection moulding method (RIM). European patent EP 1577 080 describes a method for applying a seal onto a plate. A moulding method is proposed in which a hardenable composition is deposited on at least a portion of the surface of the tool. Contrary to the injection moulding method (RIM), the hardenable composition is not injected into a closed tool but is applied either directly or indirectly onto the plate and the surface of the tool via an application device moving along the edge of the plate while applying the hardenable composition onto it. In an open tool, the composition hardens after being applied when it is in contact with the ambient air. No pressure is exerted on the tool or on the applied composition. The surface of the tool can be made from a more flexible material, for example such as a silicone material. In general, the tool comprises two portions: a first supporting portion made of metal, provided with a groove into which a second flexible portion is inserted. The flexible portion is static and does not therefore exert any pressure on the plate when the hardenable composition is applied. The plate is then placed on the second flexible portion and rests on a contact surface.

It is also known from EP 3 215 356, a method to apply a seal along the edge of a glazing and particularly along the periphery of the glazing. EP '356 describes particularly a mould with one mobile flexible cavity moving toward the edge of the glazing. There is no fixed point in the flexible cavity. The movement of the cavity may modify the geometry of the glazing. EP '356 is limited to a Window spray technology also known as WST process or gluing of a seal. In. EP '356, the mould comprises one cavity and a lower and upper mould.

U.S. Pat. No. 4,915,395 describes a mould with a lower and upper cavity, wherein the upper cavity is designed to apply a flush seal along the edge of the glazing along the periphery of the glazing.

US 2005/221060 describes a mould to method to apply a seal along the edge of a glazing and particularly along the periphery of the glazing. In US'060, the mould is not flexible, the dimensional aspect of the glazing is guaranteed by the steel material.

It should be noted that the impermeability between the plate and the tool during the application or during the formation of the seal is important, regardless of the technique used. Indeed, the seal applied must be perfectly impermeable.

Today, glazed roofs are increasingly being substituted for traditional roofs that are part of the body of vehicles. The choice of these roofs is a result of manufacturers offering to their customers this option, which makes the vehicle seem like it opens onto the exterior, like a convertible, without the drawbacks of convertibles, these roofs maintaining the comfort levels of traditional sedans. To do so glazed roofs must meet many requirements. It is recommended to address safety requirements first and also air and water sealing requirements. Glazed roofs must meet regulations regarding a good sealing and fixation of the roof onto the vehicle body to avoid its detachment.

Also, today, more and more vehicles are equipped with large windshield to provide a larger field of view and to allow more natural light to enter into the vehicle.

Thus, the roof or a windshield needs to be well fixed to the vehicle's body and ensured the sealing of the roof or a windshield to the vehicle's body.

The techniques mentioned above are effective when the plate is perfectly smooth and for plate with small sizes. However, in case the plate is a glass plate of large size such as windshield or more particularly the plate is a glazed roof for vehicles, the risk of breakage during the application of the seal with known processes is increased leading to a waste of money that is inacceptable for the automotive industry.

Thus, there is a real need to have a method for applying a seal onto a plate that, in particular when the plate has large shape, still allows the application of a sealing seal onto this plate.

For this purpose, the present invention propose a solution allowing to apply on the edge of interest of the large plate, a seal answering the requirement of sealing and safety requirements but also to decrease the level of breakage of the glass plate during the application of the seal.

Accordingly, the present invention proposes a method for applying a seal onto a plate, comprising the following steps:
providing a tool comprising
   (i) at least one support element made of solid material comprising a recess, and
   (ii) a support element made of flexible material comprising a first part and a second part) said support element made of flexible material being arranged at least partially in said recess,
   (iii) means for exerting a pressure in a compensation chamber of said recess, said compensation chamber being delimited at least partially by said second part of said support element made of flexible material;
delimiting an edge of interest on a portion of the plate on which the seal will be applied,
placing the plate on the tool such that the edge of interest rests at least on said support element made of flexible material,
holding the plate on the tool in a predetermined reference position,
applying said seal on the edge of interest,
removing the plate and the seal thereof applied from the tool.

According to the present invention, the first part of the support element made of flexible material is a fixed part and the second part of the support element made of flexible material is a mobile part and the edge of interest of the plate rests at least on said mobile part of said support element made of flexible material. The support element made of flexible material is made in one piece and encompasses the edge of interest of the plate along the contour of the plate.

The use of support element made of flexible material comprising a fixed part and a mobile part and upon which the edge of interest of the plate upon which a seal will be applied, rests at least on said the mobile part of said support element made of flexible material allows to answer the requirement of sealing and safety requirements but also to decrease the level of breakage of the glass plate during the application of the seal.

According to the present invention, the support element made of flexible material comprising a fixed part and a mobile part is made in one piece. Between the fixed part and the mobile part, there is a inflection portion to fit with the shape of the edge of the plate and more particularly to a glass plate and ensure geometrical tolerances of the plate.

One particular advantage of the present invention is that the plate and more particularly a large glass plate is not in contact with the one support element made of solid material of the tool. The glass plate is on contact with the support made of flexible material. Furthermore, according to the present invention, the support element made of flexible material adapts its shape to the plate and not the plate which adapts its shape to the support element made of flexible material. Thus, according to the present invention, the mould is flexible/soft to receive the plate and more particularly a glass plate. The dimensional aspects and the flush between the seal material and the plate and more particularly a glass plate are then guaranteed. The flexible support is then adapted to the surface of the plate.

According to an embodiment, a spacer is provided in the recess between the fixed part (6a) of the support element made of flexible material and the means to maintain in place the fixed part of the support element made of flexible material of the present invention.

The spacer according to the invention acts as a wall in the recess of support element made of solid material. The spacer maintains at its position the fixed part of the support element made of flexible material. The spacer allows also to guide the means of pressure to ensure the flexion of the mobile part of the support element made of flexible material to adjust to the plate. The spacer may be integrally formed in the recess provided in the support element made of solid material. Thus, the spacer may be made in the same material than the support element made of solid material.

The method according to the invention is characterized in that a pressure is exerted, during the application of the seal, to an outer surface of the element made of flexible material, the outer surface being opposite to the surface on which the edge of interest rests in such a way that the element made of flexible material is pressed against the plate.

The exertion of a pressure on an element made of flexible material along the edge of interest pushes the latter against the plate, and in particular compensates for the shape defects present in the plate. Thus, there will be no leaks of material while the seal is applied, and the adhesion of the seal to the plate is continuous along the entire edge of interest.

In a first preferred embodiment according to the invention, said exerted pressure is at least equal to 0.5 bar.

According to an embodiment of the present invention, exerting a pressure to the surface on which the edge of interest rests in such a way that the element made of flexible material is pressed against the plate during the application of the seal, has the advantage that the element made of flexible material is adequately pushed against the plate without the risk of the plate breaking.

According to an embodiment of the present invention, a reactive mixture containing polyurethane, formulated to produce an elastomer material containing polyurethane and having a density greater than 400 kg/m<3>, is applied as the hardenable composition as the seal to be applied on the edge of interest of the plate.

According to anther embodiment of the present invention, the seal is a resin that cures under heating or is a bi-component made of plastic and silicone.

This has the advantage of ensuring the mechanical properties of the seal. Being a vehicle window or a glazed roof, the plate provided with its seal can also be placed in the body of a vehicle and guarantee the impermeability of the panes of glass.

According to an embodiment of the present invention, the support element made of flexible material is made in one piece and encompasses the edge of interest of the plate along all the periphery of the plate.

According to an embodiment of the present invention, the support element made of flexible material is preformed according to the design of the plate and the seal and placed into the recess of the support element made of solid material of the tool.

Thus, the support element made of flexible material is easily placed in the recess provided in the element made of flexible material, simplifying the number of manipulation by the technician and consequently the cost of the process of sealing while ensuring a good sealing.

According to the present invention, the support element made of flexible material is made of an elastic material. The elastic material has a Shore A hardness of less than 90.

An elastic material having a Shore A hardness of less than 90 has the advantage that the pressure that is exerted on an outer surface of the element made of flexible material can be transmitted to the contact surface. At the same time, the risk of the plate breaking remains very limited. In the context of the present invention, “the Shore A hardness scale” refers to the durometer hardness scale as defined by the standard ASTM D2240 (2010).

The invention relates also to vehicular roofs formed, at least in part, from a glazing unit. More precisely, the invention relates to roofs the glazing unit of which covers a large portion of their area or even all of the latter.

It is understood that the present invention is applicable to plate for automotive field. More particularly, it is understood that the term automotive comprises vehicle (car), bus, train, plane, boat . . .

For a better understanding of the present invention, reference will now be made, as an example, to the appended drawings in which:

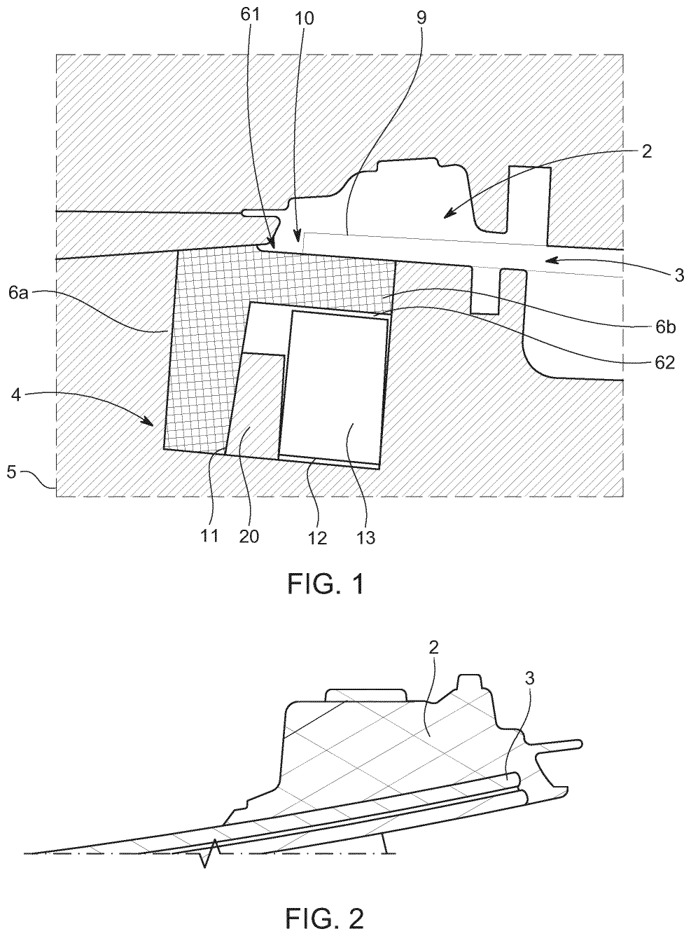

FIG. 1 is a transverse cross-sectional view of the device used in the method for applying a seal onto a plate using a hardenable composition.

FIG. 2 is a cross-sectional view of the plate provided with a seal.

In the drawings, identical or equivalent features have the same reference signs.

A seal is generally applied onto at least a portion of the contour of a plate and at least partially envelops the edges of the latter. In the specific case of a pane of glass for a vehicle, the seal is generally applied along at least one edge of the pane of glass in order to ensure impermeability when the pane of glass is inserted into the body of the vehicle. In the rest of the description, the edge of interest means the portion of the plate onto which the application of the seal is required for the future use thereof. Thus, the edge of interest can be a portion of the contour, the entire contour of the plate, or another portion of the plate or a seal must be applied. Moreover, the seal can be applied onto a single face, onto two faces of the plate and/or onto the peripheral edge face of the latter. The object of the present invention can be used in all of these cases. The term plate is used throughout the description. A plate can be a pane of glass, a pane of plexiglass, a solar panel, a synthetic or metal material or more generally any type of plate requiring a seal to be applied. Moreover, in the present invention, a seal can be an element RECTIFIED SHEET (RULE 91) ISA/EP allowing a function of impermeability between two elements to be carried out or a connection between two elements, but can also be a member placed on an element purely for cosmetic purposes.

FIG. 1 illustrates an embodiment of the application of a seal 2 onto a plate 3. In this first embodiment, the seal 2 is produced by applying a hardenable composition via an applicator 16 that injects the hardenable composition at one point with a pressure and the hardenable composition moves along the edge of interest of the plate 3. The seal 2 adheres to the plate after the application and the hardening of the composition on the edge of interest.

When a seal is applied onto a plate, the plate is generally placed on a tool, the dimensions of the surface of which are comparable to the dimensions of the plate. In the case of a windshield for a vehicle onto which a seal is applied along three edges, the tool will at least support the plate along the entirety of these three edges. In the case of a roof for a vehicle onto which a seal is applied along four edges, the tool will at least support the plate along the entirety of these four edges. A system for maintaining the plate on the tool in a predetermined reference position (not shown), such as suction cups, can be used to immobilize the plate 3 in its reference position.

FIG. 1 is a cross-sectional view of the tool 4 used to apply the seal 2. The tool 4 comprises a supporting element 5 made of solid material and an element 6 made of flexible material.

Preferably, the supporting element 5 made of solid material comprises a longitudinal recess 11 suitable for receiving the element 6 made of flexible material. This recess 11 preferably extends around the entire contour of the tool, like a groove, and can thus also completely or partially form a loop along the edge of interest of the plate when the latter is introduced into the tool. This tool is adapted for a predetermined plate shape. The tool 4 can, however, also comprise a plurality of separate linear sections along each side of the contour.

The element 6 made of flexible material comprises a fixed part 6a and a mobile part 6b. In FIG. 1, the fixed part 6a and the mobile part 6b of the element 6 are positioned like the steps of a staircase. The fixed part 6a of the element 6 is pressed against a wall of the recess 11.

According to one embodiment of the present invention, the fixed part 6a of the element 6 is immobilized against the wall of the recess 11 thanks to a spacer 20.

The shape of the spacer 20 depends on the shape of the element 6 made of flexible material and is preferably complementary to the shape of the element made of flexible material element 6 and more particularly the fixed part 6a and the mobile part 6b. The shape of the spacer 20 may depends also on the shape and the type of means of pressure 13.

The plate 3 comprises a first and a second face, respectively 8 and 9, opposite to each other and a peripheral edge face 10. The plate 3 is placed in the tool 4 in such a way that the edge of interest rests on the upper face 61 of the mobile part 6b of the element 6 made of flexible material.

One particular advantage of the present invention is that the plate and more particularly a large glass plate is not in contact with the one support element made of solid material of the tool. The glass plate is on contact with the support made of flexible material.

An advantage of using the element 6 made of flexible material with a fixed part 6a and a mobile part 6b is that the seal applied onto the edge of interest of the plate may be flush with the peripheral edge face 10. In that case, the seal does not overflow on the edge of the glass giving a good aesthetic.

The shape of the recess 11 depends on the shape of the element made of flexible material and is preferably complementary to the shape of the element made of flexible material. In this embodiment, the recess 11 consists of two cavity portions, one being deeper than the other, wherein the shape of the cross-section of each is substantially rectangular, as illustrated in FIG. 1, in such a way that the deepest portion of the cavity is suitable for receiving the leg of the element made of flexible material and the least deep portion is suitable for receiving the head.

Preferably, the depth of the recess 11, or more specifically of the two cavity portions, is slightly greater than the height of the element 6 made of flexible material in such a way that the latter can slide and be inserted into the recess 11. Advantageously, the width of the recess 11 substantially corresponds to the width of the element 6 made of flexible material.

Advantageously, the recess 11 is dimensioned in such a way that the element made of flexible material cannot escape from the supporting element 5 made of solid material when the plate is inserted into the tool 4, the head of the element 6 made of flexible material rests against a wall of the recess 11, the leg is inserted sufficiently deeply into the deepest portion of the cavity, and the plate 3 rests on the upper face 7a of the leg. It is obvious that more sophisticated locking systems could be provided.

When the element 6 made of flexible material is inserted into the recess 11, a compensation chamber 12 is formed by the lower face of the mobile part 6b of the element 6 made of flexible material and the walls of the deepest cavity of the recess 11. The supporting element 5 may comprise a duct connecting the compensation chamber 12 to the outside of the tool, preferably to means 13 for exerting a pressure.

The tool 4 supports the plate at least along the entire edge of interest. The element made of flexible material and the recess 11 extend at least along the edge of interest of the plate in the tool.

In the example illustrated in FIG. 1, the means 13 for exerting a pressure advantageously comprise a pump allowing the injection and the extraction of a fluid such as a gas or a liquid. The pump is thus connected to the compensation chamber 12 via a duct. The means of pressure 13 thus exert a pressure on the mobile part 6b of the element 6 made of flexible material leading to push the mobile part 6b of the element 6 made of flexible material against the first face 8 of the plate to maintain in place the plate during the sealing process. It is understood that the means of pressure 13 may be any suitable means able to exert a pressure while keeping the edge of the plate without any damage.

In another embodiment, the means 13 for exerting a pressure comprise springs or bladders provided in the compensation chamber 12.

The arrangement of the plate 3, the element 6 made of flexible material and the applicator (not shown) determines the final shape of the seal. The applicator, in a preferred embodiment injects at one point the hardenable composition to the surface 61 on which the plate 3 rests and then the hardenable composition flows along the edge of interest of the plate 3, preferably applies the hardenable composition perpendicularly to the surface 7a on which the plate 3 rests. Thus, advantageously, the hardenable composition is deposited in the space located between the edge face 10 and the fixed part 6a of the element 6 made of flexible material against. The dimension of this space determines the dimension of the seal. A portion of the hardenable composition is also deposited on the second face 9 of the plate.

The fixed part 6a of the element 6 made of flexible material is preferably provided with a cutting edge. The cutting edge comprises a sharp upper portion, the radius of curvature of which is preferably less than 1 mm. The cutting edge 15 is located beyond the peripheral edge face 10 of the plate 3, thus forming a first edge preventing the hardenable composition from flowing onto the supporting element 5. The hardenable composition that is deposited on the surface 7c upstream of the cutting edge 15 forms the lip of the seal. It is generally the lip that provides the seal when a pane of glass is installed in the body. Preferably, the hardenable composition is applied via a pouring method using an applicator 16 provided with a nozzle.

According to the invention, the seal applied onto the edge of interest of the plate may be flush with the and the peripheral edge face 10.

According to another embodiment of the present invention, the upper face 61 of the may comprise a recess such that the seal can also be applied onto the edge of the first face 8. Thus, the seal is applied not only onto the end of the face 9 and onto the peripheral edge face 10, but also onto the end of the face 8.

The hardenable composition is preferably applied using an applicator 16 such as a nozzle. For the present invention, various types of nozzles can be used to generate various flow configurations.

Preferably, the supporting element 5 made of solid material can be made of metal. Advantageously, the material of the element 6 made of flexible material comprises a deformable plastic, preferably a polymer or an elastomer, and even more advantageously a silicone. Preferably, the material of the element 6 made of flexible material must be chosen in such a way that when it is pushed against the plate 3, it is compressed against the plate in such a way as to make the contact surface impermeable, even in the presence of deformations in the plate 3. Nevertheless, the material of the element 6 made of flexible material must also be sufficiently rigid for the pressure exerted on the latter to not deform its parts. These two conditions on the rigidity of the element 6 made of flexible material ensure the absence of interstices between the element 6 made of flexible material and the edge of interest of the plate 3 while the seal 2 is applied, in such a way that the seal can be correctly formed on the edge of interest of the plate 3, without leaks of materials.

The upper face 61 can be made, at least partially, but preferably substantially totally from an elastic material having a Shore A hardness of less than 90, and more particularly less than 60. The element 6 made of flexible material can thus be, for example, made from a silicon material. Consequently, the element 6 made of flexible material can be easily produced via moulding in a master mould or via extrusion. Because of the elastic nature of the element 6 made of flexible material, the master mould does not need to be manufactured in a very precise way, and does not need to be refined in such a way that is costs less to manufacture.

Advantageously, in a first step not shown in the figures, the tool 4 is prepared and cleaned. The element made of flexible material 6 is inserted into the recess 11 of the tool 4, resulting in the formation of the compensation chamber 12 inside the tool 4. Advantageously, the plate 3 is also cleaned in order to improve the adhesion of the seal to the plate.

According to one embodiment of the present invention, the supporting element 5 made of solid material is heated to a temperature between 30 and 100° C., preferably between 45 and 75° C. This allows the speed of the hardening reaction, which is faster as temperatures greater than the ambient temperature, to be increased.

In a second step, the plate 3 is placed in the tool 4 in such a way that the plate 3 rests, at least at the edge of interest, on the upper face 61 of the element 6 made of flexible material. A contact surface 18 is thus created between the upper face 61 of the element 6 made of flexible material and the face 8 of the plate 3. However, the weight of the plate 3 is not sufficient to ensure impermeability along the entire contact surface 18.

However, as indicated above, irregularities or local deformations in the plate 3 can create local interstices between the upper face 7a and the edge of the plate 3. The impermeability between the plate 3 and the upper face 7a is required along the entire edge of interest for the application of the seal. This impermeability is necessary to prevent the leaking of material while the seal is applied.

In a third step, a pressure is exerted on the lower face 62 of the element made of flexible material in the compensation chamber 12. The pressure is exerted there using means 13 for exerting a pressure. The pressure exerted in the compensation chamber 12 is greater than the pressure of the ambient environment, which generally corresponds to atmospheric pressure.

This pressure generates a thrust of the element 6 made of flexible material in the direction of the plate 3. A counter-pressure is thus generated on the contact surface between the plate 3 and the upper surface 61 of the element made of flexible material. This local counter-pressure generated on the contact surface ensures local impermeability between the edge of the plate 3 and the element 6 made of flexible material. An improved seal is thus obtained, even in places comprising irregularities or local deformations, before deposition of the hardenable composition.

Preferably, in order to ensure this impermeability continuously along the edge of interest, the pressure is exerted locally at various predetermined locations. These locations can be equidistant or not and are dependent on the arrangement of the various ducts 14 along the support 5 made of solid material.

Advantageously, a lubricant is deposited between the walls of the mobile part 6b of the element made of flexible material and the walls of the recess 11 in order to facilitate the sliding of the element made of flexible material 6 in the recess 11. The use of a lubricant also has the advantage that it prevents the flow of the fluid from the compensation chamber 12, in order to maintain the pressure in the compensation chamber 12 at a constant level or modify, in a stable manner, the pressure level without abrupt changes. The lubricant used can be, in particular, water or oil.

The hardenable composition preferably comprises a reaction mixture of polyurethane, comprising a polyol and an isocyanate component. The hardenable composition is preferably formulated to produce an elastomer polyurethane material having a density greater than 400 kg/m<3> and preferably greater than 500 kg/m<3>.

The hardenable composition can also be applied at ambient temperature, for example. However, in order to accelerate the hardening reaction, the hardenable composition is generally applied at a higher temperature, for example onto a heated surface. In one embodiment of the present invention, the supporting element 5 made of solid material of the tool 4 is made of metal and is heated to a temperature between 30 and 100° C., preferably between 45 and 75° C.

In a fifth step, after the hardening of the hardenable composition, the means for exerting a pressure 13 are stopped, the pressure in the compensation chamber 12 is lowered, and the element 6 made of flexible material moves back down into the recess 11. The plate 3 and the seal 2 produced on said plate are then removed from the tool 4.

During the process of hardening, the hardenable composition is in contact with the upper face 61 of the element 6 made of flexible material, the peripheral edge face 10 of the plate 3, or with a gas. No additional external pressure is exerted on the seal 2 or on the element 6 made of flexible material.

The element 6 made of flexible material is visible from outside the device 1. Thus, a simple visual inspection allows the state of the element made of flexible material to be determined. If the element 6 made of flexible material requires replacement, it can be easily and quickly removed from the supporting element 5 made of solid material, without having to detach other elements. The wear on the tool will be limited to the element 6 made of flexible material that can be replaced. Indeed, during normal use, the seal does not come in contact with the supporting element made of solid material. The device 1 is therefore simple to maintain.

FIG. 2 illustrates an embodiment of a plate 3 provided on the edge of interest a seal 2 applied according to the present invention.

The plate shown in the FIG. 2 is a glass laminated roof for vehicle. The seal 2 is flush with the bottom face of the glass plate. The seal 2 thanks to the present invention is well fixed along the periphery of the roof ensuring a good sealing.

1: A method for applying a seal onto a plate, comprising:
providing a tool, comprising:
at least one support element made of solid material comprising a recess,
a support element made of flexible material comprising a first part and a second part wherein said support element made of flexible material is arranged at least partially in said recess, and
a means for exerting pressure in a compensation chamber of said recess, wherein said compensation chamber is delimited at least partially by said second part of said support element made of flexible material;
delimiting an edge of interest on a portion of the plate on which the seal is to be applied,
placing the plate on the tool such that the edge of interest rests at least on said support element made of flexible material,
holding the plate on the tool in a predetermined reference position,
applying said seal on the edge of interest, and
removing the plate and the seal thereof applied from the tool,
wherein the first part of the support element made of flexible material is a fixed part and the second part is a mobile part of the support element made of flexible material, and
wherein the edge of interest of the plate rests at least on said mobile part of said support element made of flexible material and that the support element made of flexible material is made in one piece and encompasses the edge of interest of the plate along a contour of the plate.

2: The method according to claim 1, wherein a spacer is provided in the recess between the fixed part of the support element made of flexible material and means to maintain in place the fixed part of the support element made of flexible material.

3: The method according to claim 1, wherein said support element made of flexible material is made of an elastic material having a Shore A hardness of less than 90.

4: The method according to claim 1, wherein the means for exerting pressure is a means wherein air is injected.

5: The method according to claim 2, wherein said spacer is part of the support element made of solid material.

6: The method according to claim 1, wherein said plate is a glass plate.

7: The method according to claim 1, wherein said plate is an automotive glazing selected from a roof n a windshield.

8: The method according to claim 1, wherein said support element made of flexible material is configured to fit with edges of the plate along a periphery of the plate.

9: The method according to claim 1, wherein the seal is a reactive mixture containing polyurethane, formulated to produce an elastomer material containing polyurethane and having a density greater than 400 kg/m³, applied as a hardenable composition.

10: The method according to claim 1, wherein an elastic material having a Shore A hardness of less than 90 is used on at least a surface of the support element made of flexible material,
and wherein the plate rests on the elastic material.

11: The method according to claim 1, wherein the seal is flush with the edge of interest on a portion of the plate on which the seal is to be applied.

12: A tool for performing a method for applying a seal onto a plate, comprising:
at least one support element made of solid material comprising a recess,
a support element made of flexible material comprising a first part and a second part wherein said support element made of flexible material is arranged at least partially in said recess, and
a means for exerting pressure in a compensation chamber of said recess, wherein said compensation chamber is delimited at least partially by said second part of said support element made of flexible material;
wherein the first part of the support element made of flexible material is a fixed part and the second part is a mobile part of the support element made of flexible material and
wherein an edge of interest of the plate rests at least on said mobile part of said support element made of flexible material.
